(19) United States
(12) Patent Application Publication
(10) Pub. No.: US 2019/0190078 A1
(43) Pub. Date: Jun. 20, 2019

(54) NONAQUEOUS ELECTROLYTE SECONDARY BATTERY

(71) Applicant: Sumitomo Chemical Company, Limited, Tokyo (JP)

(72) Inventors: Ichiro ARISE, Osaka (JP); Toshihiko OGATA, Osaka (JP); Chikara MURAKAMI, Osaka (JP); Hiroki HASHIWAKI, Niihama-shi (JP)

(21) Appl. No.: 16/224,792

(22) Filed: Dec. 19, 2018

(30) Foreign Application Priority Data
Dec. 19, 2017 (JP) 2017-243288

(51) Int. Cl. H01M 10/0585; H01M 10/0525; H01M 2/16; H01M 4/133; H01M 4/131; H01M 4/583

(52) U.S. Cl. CPC H01M 10/0585; H01M 10/0525; H01M 2/16; H01M 2004/021; H01M 4/131; H01M 4/583; H01M 4/133

(57) ABSTRACT

The present invention provides a nonaqueous electrolyte secondary battery in which degradation of electrode plates after charge-discharge cycles is prevented. The nonaqueous electrolyte secondary battery in accordance with an aspect of the present invention includes: (i) a combination of a positive electrode plate and a negative electrode plate in which the sum of interface barrier energies is not less than a predetermined value, (ii) a nonaqueous electrolyte secondary battery separator that includes a porous film whose parameter X falls within a predetermined range, the parameter X being calculated from a tan δ which is obtained through a viscoelasticity measurement, and (iii) a porous layer that contains an α-form polyvinylidene fluoride-based resin of a polyvinylidene fluoride-based resin at a predetermined proportion. The porous layer is provided between the nonaqueous electrolyte secondary battery separator and at least one of the positive electrode plate and the negative electrode plate.

This Nonprovisional application claims priority under 35 U.S.C. §119 on Patent Application No. 2017-243288 filed in Japan on Dec. 19, 2017, the entire contents of which are hereby incorporated by reference.

### TECHNICAL FIELD

The present invention relates to a nonaqueous electrolyte secondary battery.

### BACKGROUND ART

Nonaqueous electrolyte secondary batteries, in particular, lithium secondary batteries have a high energy density, and are thus in wide use as batteries for a personal computer, a mobile telephone, a portable information terminal, and the like. Such nonaqueous electrolyte secondary batteries have recently been developed as on-vehicle batteries.

For example, Patent Literature 1 discloses a nonaqueous electrolyte secondary battery including a nonaqueous electrolyte secondary battery separator which contains a polyolefin porous film having a small amount of anisotropy of tan δ obtained through a viscoelasticity measurement.

### CITATION LIST

### Patent Literature

Patent Literature 1: Japanese Patent No. 6025957 (Publication Date: Nov. 16, 2016)

### SUMMARY OF INVENTION

### Technical Problem

An object to be attained by an aspect of the present invention is to provide a nonaqueous electrolyte secondary battery in which degradation of electrode plates after charge-discharge cycles is prevented.

### Solution to Problem

The present invention encompasses the following features. <1>A nonaqueous electrolyte secondary battery including: a nonaqueous electrolyte secondary battery separator including a polyolefin porous film; a porous layer containing a polyvinylidene fluoride-based resin; a positive electrode plate; and a negative electrode plate,

in a case where the positive electrode plate and the negative electrode plate have each been processed into a disk having a diameter of 15.5 mm and immersed in a solution of ethylene carbonate, ethyl methyl carbonate, and diethyl carbonate which solution contains LiPF₆ at a concentration of 1 M, a sum of respective interface barrier energies measured of a positive electrode active material and a negative electrode active material being not less than 5000 J/mol,

the polyolefin porous film having a parameter X of not more than 20, the parameter X being calculated in accordance with a formula below, where MD tan δ represents a tan δ measured in a machine direction through a viscoelasticity measurement performed at a frequency of 10 Hz and a temperature of 90° C., and TD tan δ represents a tan δ measured in a transverse direction through the viscoelasticity measurement,

X=100×|MD tan δ−TD tan δ|/{(MD tan δ+TD tan δ)/2}

the porous layer being provided between the nonaqueous electrolyte secondary battery separator and at least one of the positive electrode plate and the negative electrode plate,

the polyvinylidene fluoride-based resin contained in the porous layer containing an α-form polyvinylidene fluoride-based resin in an amount of not less than 35.0 mol % with respect to 100 mol % of a combined amount of the α-form polyvinylidene fluoride-based resin and a β-form polyvinylidene fluoride-based resin contained in the polyvinylidene fluoride-based resin,

a content of the α-form polyvinylidene fluoride-based resin being calculated by (i) waveform separation of (α/2) observed at around −78 ppm in a ¹⁹F-NMR spectrum obtained from the porous layer and (ii) waveform separation of {(α/2)+β} observed at around −95 ppm in the ¹⁹F-NMR spectrum obtained from the porous layer.

<2>The nonaqueous electrolyte secondary battery which is described in <1>and in which the positive electrode plate contains a transition metal oxide.

<3>The nonaqueous electrolyte secondary battery which is described in <1>or <2>and in which the negative electrode plate contains graphite.

<4>The nonaqueous electrolyte secondary battery which is described in any one of <1>through <3>and in which the nonaqueous electrolyte secondary battery further includes another porous layer which is provided between (i) the nonaqueous electrolyte secondary battery separator and (ii) at least one of the positive electrode plate and the negative electrode plate.

<5>The nonaqueous electrolyte secondary battery which is described in <4>and in which the another porous layer contains at least one resin selected from the group consisting of a polyolefin, a (meth)acrylate-based resin, a fluorine-containing resin (excluding a polyvinylidene fluoride-based resin), a polyamide-based resin, a polyester-based resin, and a water-soluble polymer.

<6>The nonaqueous electrolyte secondary battery which is described in <5>and in which the polyamide-based resin is aramid resin.

### Advantageous Effects of Invention

According to an aspect of the present invention, it is possible to provide a nonaqueous electrolyte secondary battery in which degradation of electrode plates after charge-discharge cycles is prevented.

### DESCRIPTION OF EMBODIMENTS

[1. Nonaqueous electrolyte secondary battery in accordance with an aspect of the present invention]

A nonaqueous electrolyte secondary battery in accordance with an aspect of the present invention includes (i) a separator for a nonaqueous electrolyte secondary battery (hereinafter referred to as a “nonaqueous electrolyte secondary battery separator” or referred to simply as “separator”) including a polyolefin porous film (hereinafter referred to also as “porous film”), (ii) a porous layer containing a polyvinylidene fluoride-based resin, (iii) a positive electrode plate, and (iv) a negative electrode plate,

in a case where the positive electrode plate and the negative electrode plate have each been processed into a disk having a diameter of 15.5 mm and immersed in a solution of ethylene carbonate, ethyl methyl carbonate, and diethyl carbonate which solution contains LiPF₆ at a concentration of 1 M, a sum of respective interface barrier energies measured of a positive electrode active material and a negative electrode active material (hereinafter referred to also as “sum of the interface barrier energies) being not less than 5000 J/mol,

the polyolefin porous film having a parameter X of not more than 20, the parameter X being calculated in accordance with a formula below, where MD tan δ represents a tan δ measured in a machine direction through a viscoelasticity measurement performed at a frequency of 10 Hz and a temperature of 90° C., and TD tan δ represents a tan δ measured in a transverse direction through the viscoelasticity measurement,

X=100×|MD tan δ−TD tan δ|/{(MD tan 67 +TD tan δ)/2}

the porous layer being present between the nonaqueous electrolyte secondary battery separator and the positive electrode plate and/or between the nonaqueous electrolyte secondary battery separator and the negative electrode plate,

the polyvinylidene fluoride-based resin contained in the porous layer containing an α-form polyvinylidene fluoride-based resin in an amount of not less than 35.0 mol % with respect to 100 mol % of a combined amount of the α-form polyvinylidene fluoride-based resin and a β-form polyvinylidene fluoride-based resin contained in the polyvinylidene fluoride-based resin,

a content of the α-form polyvinylidene fluoride-based resin being calculated by (i) waveform separation of (α/2) observed at around −78 ppm in a ¹⁹F-NMR spectrum obtained from the porous layer and (ii) waveform separation of {(α/2)+β} observed at around −95 ppm in the ¹⁹F-NMR spectrum obtained from the porous layer.

With a combination of the positive electrode plate and the negative electrode plate in which the sum of the interface barrier energies falls within the aforementioned range, ions and electric charge in the respective active material surfaces of the positive electrode active material layer and the negative electrode active material layer move uniformly during charge-discharge cycles. This makes the reactivity of the entire active material moderate and uniform and thus prevents (i) the internal structure of the active material layer from changing easily and (ii) the active material itself from degrading easily.

Further, a porous film having the parameter X that falls within the above described range, the parameter X being calculated from a tan δ obtained through a viscoelasticity measurement, has a strong tendency to isotropically deform following a change in external stress. In other words, the porous film has a strong tendency to homogeneously deform in a surface direction thereof. This consequently makes it less likely for, for example, falling off of an electrode active material to occur.

The porous layer in which a rate of content of an α-form polyvinylidene fluoride-based resin in the polyvinylidene fluoride-based resin falls within the above described range can inhibit plastic deformation of the polyvinylidene fluoride-based resin at a high temperature. As a result, structural deformation of the porous layer and blockage of voids in the porous layer are prevented.

By selecting the above constituent members, the nonaqueous electrolyte secondary battery in accordance with an aspect of the present invention brings about a novel effect of preventing deterioration of electrode plates after charge-discharge cycles. As a specific example, the nonaqueous electrolyte secondary battery in accordance with an aspect of the present invention maintains a good discharge capacity maintaining rate at 0.2 C after 100 cycles, as compared with a conventional nonaqueous electrolyte secondary battery.

According to the nonaqueous electrolyte secondary battery in accordance with an aspect of the present invention, the discharge capacity maintaining rate at 0.2 C after 100 cycles is preferably not less than 84%, more preferably not less than 85%, and even more preferably not less than 86%.

The discharge capacity maintaining rate at 0.2 C after 100 cycles can be calculated by the following procedures (1) through (5): Note that “1 C” hereinafter refers to a value of an electric current at which a battery rated capacity defined as a one-hour rate discharge capacity maintaining rate is discharged in one hour. The “CC-CV charge” refers to a charging method in which (i) a battery is charged at a constant electric current until a certain voltage is reached, and (ii) after that, the battery is charged while the electric current is being reduced so that the certain voltage is maintained. The “CC discharge” refers to a discharging method in which a battery is discharged at a constant electric current until a certain voltage is reached.
(1) A prepared nonaqueous electrolyte secondary battery is subjected to four cycles of initial charge and discharge at 25° C. Each of the four cycles of initial charge and discharge is carried out as follows. Specifically, each of the four cycles of initial charge and discharge is carried out at a voltage ranging from 2.7 V to 4.1 V, with (i) CC-CV charge at a charge current value of 0.2 C (terminal current condition: 0.02 C) and then with (ii) CC discharge at a discharge current value of 0.2 C.
(2) Measurement of a discharge capacity at 0.2 C before cycles is made on the nonaqueous electrolyte secondary battery. The nonaqueous electrolyte secondary battery is subjected to three cycles of charge and discharge. Each of the three cycles of charge and discharge is carried out as follows. Specifically, charge and discharge are carried out at a voltage ranging from 2.7 V to 4.2 V, with (i) CC-CV charge at a charge current value of 1 C (terminal current condition: 0.02 C) and then with (ii) CC discharge at a discharge current value of 0.2 C. A discharge capacity at the third cycle is used as the “discharge capacity at 0.2 C before cycles”.
(3) The nonaqueous electrolyte secondary battery having been subjected to the initial charge and discharge is subjected to 100 cycles of cycle test at 55° C. Each of the 100 cycles of cycle test is carried out as follows. Specifically, charge and discharge are carried out at a voltage ranging from 2.7 V to 4.2 V, with (i) CC-CV charge at a charge current value of 1 C (terminal current condition: 0.02 C) and then with (ii) CC discharge at a discharge current value of 10 C.
(4) Measurement of a discharge capacity at 0.2 C after cycles is made on the nonaqueous electrolyte secondary battery having been subjected to the cycle test. A specific measurement method is similar to the method in (2). A discharge capacity at the third cycle is used as the “discharge capacity at 0.2 C after cycles”.
(5) A value given by {(discharge capacity at 0.2 C after cycles)/(discharge capacity at 0.2 C before cycles)}×100 (%) is used as a “discharge capacity maintaining rate at 0.2 C after 100 cycles”. A result of a test for a discharge capacity maintaining rate at 0.2 C after 100 cycles represents irreversible degradation of an active material caused by charge and discharge.

[2. Positive electrode plate and negative electrode plate]

(Positive Electrode Plate)

The positive electrode plate included in a nonaqueous electrolyte secondary battery in accordance with an embodiment of the present invention is not limited to any particular one as long as the following requirement is met: In a case where the positive electrode plate and the negative electrode plate (described later) have each been processed into a disk having a diameter of 15.5 mm and immersed in a solution of ethylene carbonate, ethyl methyl carbonate, and diethyl carbonate which solution contains LiPF₆ at a concentration of 1 M, the sum of the respective interface barrier energies measured of the positive electrode plate and the negative electrode plate is not less than 5000 J/mol. For example, the positive electrode plate is a sheet-shaped positive electrode plate including, (i) as a positive electrode active material layer, a positive electrode mix containing a positive electrode active material, an electrically conductive agent, and a binding agent and (ii) a positive electrode current collector supporting the positive electrode mix thereon. Note that the positive electrode plate may be configured such that the positive electrode current collector supports the positive electrode mix on both surfaces thereof or on one of the surfaces thereof.

The positive electrode active material is, for example, a material capable of being doped with and dedoped of lithium ions. Such a material is preferably transition metal oxide. Examples of the transition metal oxide encompass lithium complex oxides containing at least one transition metal including, for example, V, Mn, Fe, Co, and Ni. Among such lithium complex oxides, (i) a lithium complex oxide having an α-NaFeO₂ structure such as lithium nickelate and lithium cobaltate and (ii) a lithium complex oxide having a spinel structure such as lithium manganese spinel are preferable because such lithium complex oxides have a high average discharge potential. The lithium complex oxide may further contain any of various metallic elements, and is further preferably complex lithium nickelate.

Further, the complex lithium nickelate furthermore preferably contains at least one metallic element selected from the group consisting of Ti, Zr, Ce, Y, V, Cr, Mn, Fe, Co, Cu, Ag, Mg, Al, Ga, In, and Sn at a proportion of 0.1 mol % to 20 mol % with respect to the sum of the number of moles of the at least one metallic element and the number of moles of Ni in the lithium nickelate. This is because such a complex lithium nickelate allows an excellent cycle characteristic for use in a high-capacity battery. Among others, an active material that contains Al or Mn and that contains Ni at a proportion of not less than 85%, further preferably not less than 90%, is particularly preferable because a nonaqueous electrolyte secondary battery including a positive electrode plate containing the above active material has an excellent cycle characteristic for use as a high-capacity battery.

Examples of the electrically conductive agent include carbonaceous materials such as natural graphite, artificial graphite, cokes, carbon black, pyrolytic carbons, carbon fiber, and a fired product of an organic polymer compound. The present embodiment may use (i) only one kind of the above electrically conductive agents or (ii) two or more kinds of the above electrically conductive agents in combination, for example a mixture of artificial graphite and carbon black.

Examples of the binding agent include thermoplastic resins such as polyvinylidene fluoride, a copolymer of vinylidene fluoride, polytetrafluoroethylene, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-hexafluoropropylene copolymer, a vinylidene fluoride-hexafluoropropylene-tetraflu oro ethylene copolymer, a thermoplastic polyimide, polyethylene, and polypropylene; an acrylic resin; and styrene-butadiene rubber. The binding agent functions also as a thickening agent.

The positive electrode mix may be prepared by, for example, a method of applying pressure to the positive electrode active material, the electrically conductive agent, and the binding agent on the positive electrode current collector or a method of using an appropriate organic solvent so that the positive electrode active material, the electrically conductive agent, and the binding agent are in a paste form.

Examples of the positive electrode current collector include electric conductors such as Al, Ni, and stainless steel. Among these, Al is preferable as it is easy to process into a thin film and less expensive.

The sheet-shaped positive electrode plate may be produced, that is, the positive electrode mix may be supported by the positive electrode current collector, through, for example, a method of applying pressure to the positive electrode active material, the electrically conductive agent, and the binding agent on the positive electrode current collector to form a positive electrode mix on the positive electrode current collector or a method of (i) using an appropriate organic solvent so that the positive electrode active material, the electrically conductive agent, and the binding agent are in a paste form to provide a positive electrode mix, (ii) applying the positive electrode mix to the positive electrode current collector, (iii) drying the applied positive electrode mix to prepare a sheet-shaped positive electrode mix, and (iv) applying pressure to the sheet-shaped positive electrode mix so that the sheet-shaped positive electrode mix is firmly fixed to the positive electrode current collector.

The particle diameter of the positive electrode active material is expressed as, for example, an average particle diameter (D50) per volume. The positive electrode active material normally has an average particle diameter per volume of approximately 0.1 μm to 30 μm. The average particle diameter (D50) per volume of the positive electrode active material can be measured with use of a laser diffraction particle size analyzer (product name: SALD2200, available from Shimadzu Corporation).

The positive electrode active material normally has an aspect ratio (that is, the long-axis diameter/the short-axis diameter) of approximately 1 to 100. The aspect ratio of the positive electrode active material can be determined by the following method: In an SEM image formed by observing the positive electrode active material on a flat surface from above in a direction perpendicular to the surface, the average is calculated (as the aspect ratio) of the ratios of the respective long-axis dimensions (long-axis diameters) and short-axis dimensions (short-axis diameters) of 100 particles of the positive electrode active material which 100 particles do not coincide with one another in the thickness direction of the positive electrode active material.

The positive electrode active material layer normally has a porosity of approximately 10% to 80%. The porosity (ε) of the positive electrode active material layer can be calculated, by the formula below, from a density ρ (g/m³) of the positive electrode active material layer, respective mass compositions (weight %) b¹, b², . . . bⁿ of materials that constitute the positive electrode active material layer (e.g., a positive electrode active material, an electrically conductive agent, a binding agent, and others), and respective real densities (g/m³) c¹, c², . . . cⁿ of these materials. Note here that the real densities of the materials may be literature data or may be measured values obtained by a pycnometer method.

ε=1−{ρ×(b¹/100)/c¹+ρ×(b²/100)/c²+ . . . ρ×(bⁿ/100)/cⁿ}×100

The positive electrode active material layer normally contains a positive electrode active material at a proportion of not less than 70% by weight.

The coating line speed (that is, a speed at which a positive electrode mix containing a positive electrode active material is applied to a current collector; hereinafter referred to also as “coating speed”) is within a range of 10 m/min to 200 m/min. The coating line speed during the coating operation can be adjusted by appropriately setting the device for applying a positive electrode active material.

(Negative Electrode Plate)

The negative electrode plate included in the nonaqueous electrolyte secondary battery in accordance with an embodiment of the present invention is not limited to any particular one as long as the following requirement is met: In a case where the positive electrode plate and the negative electrode plate have each been processed into a disk having a diameter of 15.5 mm and immersed in a solution of ethylene carbonate, ethyl methyl carbonate, and diethyl carbonate which solution contains LiPF₆ at a concentration of 1 M, the sum of the respective interface barrier energies measured of the positive electrode plate and the negative electrode plate is not less than 5000 J/mol. For example, the negative electrode plate is a sheet-shaped negative electrode plate including, (i) as a negative electrode active material layer, a negative electrode mix containing a negative electrode active material and (ii) a negative electrode current collector supporting the negative electrode mix thereon. Note that the negative electrode plate may be configured such that the negative electrode current collector supports the negative electrode mix on both surfaces thereof or on one of the surfaces thereof.

The sheet-shaped negative electrode plate preferably contains the above electrically conductive agent and binding agent.

Examples of the negative electrode active material include (i) a material capable of being doped with and dedoped of lithium ions, (ii) lithium metal, and (iii) lithium alloy. Specific examples of the material include carbonaceous materials such as natural graphite, artificial graphite, cokes, carbon black, pyrolytic carbons, carbon fiber, and a fired product of an organic polymer compound; chalcogen compounds such as an oxide and a sulfide that are doped and dedoped with lithium ions at an electric potential lower than that for the positive electrode plate; metals such as Al, Pb, Sn, Bi, or Si, each of which is alloyed with alkali metal; an intermetallic compound (AlSb, Mg₂Si, NiSi₂) of a cubic system in which intermetallic compound alkali metal can be inserted in voids in a lattice; and a lithium nitrogen compound (Li₃-xMₓN (where M represents a transition metal)). Of the above negative electrode active materials, a negative electrode active material containing graphite is preferable, and a carbonaceous material that contains, as a main component, a graphite material such as natural graphite or artificial graphite is more preferable. This is because such graphite and a carbonaceous material are high in potential evenness, and a great energy density can be obtained in a case where the graphite or carbonaceous material, which is low in average discharge potential, is combined with the positive electrode plate. The negative electrode active material may alternatively be a mixture of graphite and silicon, preferably containing Si at a proportion of not less than 5%, more preferably not less than 10%, with respect to C in the graphite.

The negative electrode mix may be prepared by, for example, a method of applying pressure to the negative electrode active material on the negative electrode current collector or a method of using an appropriate organic solvent so that the negative electrode active material is in a paste form.

Examples of the negative electrode current collector include Cu, Ni, and stainless steel. Among these, Cu is preferable as it is not easily alloyed with lithium particularly in a lithium-ion secondary battery and is easily processed into a thin film.

The sheet-shaped negative electrode plate may be produced, that is, the negative electrode mix may be supported by the negative electrode current collector, through, for example, a method of applying pressure to the negative electrode active material on the negative electrode current collector to form a negative electrode mix thereon or a method of (i) using an appropriate organic solvent so that the negative electrode active material is in a paste form to provide a negative electrode mix, (ii) applying the negative electrode mix to the negative electrode current collector, (iii) drying the applied negative electrode mix to prepare a sheet-shaped negative electrode mix, and (iv) applying pressure to the sheet-shaped negative electrode mix so that the sheet-shaped negative electrode mix is firmly fixed to the negative electrode current collector. The above paste preferably includes the above electrically conductive agent and binding agent.

The negative electrode active material normally has an average particle diameter (D50) per volume of approximately 0.1 μm to 30 μm.

The negative electrode active material normally has an aspect ratio (that is, the long-axis diameter/the short-axis diameter) of approximately 1 to 10.

The negative electrode active material layer normally has a porosity of approximately 10% to 60%.

The negative electrode active material layer normally contains a negative electrode active material at a proportion of not less than 70% by weight, preferably not less than 80% by weight, more preferably not less than 90% by weight.

The coating line speed (that is, a speed at which a negative electrode mix containing a negative electrode active material is applied to a current collector; hereinafter referred to also as “coating speed”) is within a range of 10 m/min to 200 m/min. The coating line speed during the coating operation can be adjusted by appropriately setting the device for applying a negative electrode active material.

The methods described under “(Positive electrode plate)” can be used to determine the particle diameter, aspect ratio, and porosity of the negative electrode active material, the proportion of the negative electrode active material in the negative electrode active material layer, and the coating speed.

(Sum of Interface Barrier Energies)

In a case where the positive electrode plate and the negative electrode plate in accordance with an embodiment of the present invention have each been (i) processed into a disk having a diameter of 15.5 mm and (ii) immersed in a solution of ethylene carbonate, ethyl methyl carbonate, and diethyl carbonate which solution contains LiPF₆ at a concentration of 1 M, the sum of the respective interface barrier energies measured of the positive electrode plate and the negative electrode plate is not less than 5000 J/mol. The sum of the interface barrier energies is preferably not less than 5100 J/mol, more preferably not less than 5200 J/mol.

In a case where the sum of the interface barrier energies is not less than 5000 J/mol, the active material surface in the active material layer allows ions and electric charge to move uniformly, and the reactivity of the entire active material layer is moderate and uniform as a result. This should prevent (i) the internal structure of the active material layer from changing easily and (ii) the active material itself from degrading easily.

If the sum of the interface barrier energies is less than 5000 J/mol, the reactivity of the active material layer will be non-uniform, whereby the internal structure of the active material layer will be changed locally, and the active material will be degraded partially (for example, generation of gas).

For the above reason, the nonaqueous electrolyte secondary battery in accordance with an embodiment of the present invention, in which the sum of the respective interface barrier energies of the positive electrode plate and the negative electrode plate is not less than 5000 J/mol, advantageously prevents degradation of electrode plates after charge-discharge cycles.

The sum of the interface barrier energies has no particular upper limit. If the sum of the interface barrier energies is excessively high, however, that will undesirably prevent ions and electric charge from moving at the active material surface and thereby prevent the active material from being easily subjected to oxidation-reduction reaction resulting from charge and discharge. The sum of the interface barrier energies has an upper limit of, for example, approximately 15,000 J/mol.

The above-described sum of the interface barrier energies is determined by measuring the respective interface barrier energies of the positive electrode active material and the negative electrode active material and calculating the sum of the interface barrier energies through the procedure below.
(1) The positive electrode plate and the negative electrode plate are each cut into a disk having a diameter of 15 mm. The polyolefin porous film is also cut into a disk having a diameter of 17 mm for use as a separator.
(2) A mixed solvent is prepared that contains ethylene carbonate (EC), ethyl methyl carbonate (EMC), and diethyl carbonate (DEC) at a volume ratio of 3:5:2. LiPF₆ is dissolved in the mixed solvent at 1 mol/L for preparation of electrolyte.
(3) In a CR2032-type electrolytic bath, the negative electrode plate, the separator, the positive electrode plate, a stainless-steel plate (with a diameter of 15.5 mm and a thickness of 0.5 mm), and a waved washer are disposed on top of each other in this order from the bottom of the electrolytic bath. Then, the electrolyte is injected into the electrolytic bath, and the electrolytic bath is lidded, with the result of a coin cell being prepared.
(4) The coin cell prepared is placed in a thermostat bath. An alternating current impedance apparatus (FRA 1255B, available from Solartron) and CellTest System (1470E) are used at a frequency of 1 MHz to 0.1 Hz and a voltage amplitude of 10 mV to draw a Nyquist plot. The thermostat bath has a temperature of 50° C., 25° C., 5° C., or −10° C.
(5) The diameter of a half arc (or an arc of a flat circle) of the Nyquist plot drawn is used to determine the resistance r₁+r₂ of the positive electrode plate and the negative electrode plate at the electrode active material interface for different temperatures. The resistance r₁+r₂ is the sum of the resistance of the positive electrode and the negative electrode to ion movement and the resistance of the positive electrode and the negative electrode to electric charge movement. The half arc may be two completely separate arcs or a flat circle made of two overlapping circles. The sum of the respective interface barrier energies of the positive electrode active material and the negative electrode active material is calculated in accordance with Expressions (1) and (2) below.

k=1/(r₁+r₂)=Aexp(−Ea/RT) . . . Expression (1)

1n(k)=1n{1/(r₁+r₂)}=1n(A)−Ea/RT . . . Expression (2)
Ea: Sum of the respective interface barrier energies of the positive electrode active material and the negative electrode active material (J/mol)
k: Transfer constant
r₁+r₂: Resistance (Ω)
A: Frequency factor
R: Gas constant=8.314 J/mol/K
T: Temperature of the thermostat bath (K)

Expression (2) is an expression in which natural logarithms of both sides of Expression (1) are taken. In Expression (2), 1n{1/(r₁+r₂)} is a linear function of 1/T. Thus, Ea/R is determined from the inclination of an approximate line obtained by plotting the results of substituting the resistance value at each temperature into Expression (2). Substituting the gas constant R into Ea/R allows the sum Ea of the respective interface barrier energies to be calculated.

The frequency factor A is a unique value that does not vary according to temperature changes. This value is determined depending on, for example, the molar concentration of lithium ions in the electrolyte bulk. According to Expression (2), the frequency factor A is the value of 1n(1/r₀) for a case where (1/T)=0, and can be calculated on the basis of the above approximate line.

The sum of the interface barrier energies can be controlled on the basis of, for example, the ratio of the respective particle diameters of the positive electrode active material and the negative electrode active material. The ratio of the respective particle diameters of the positive electrode active material and the negative electrode active material, that is, (the particle diameter of the negative electrode active material/the particle diameter of the positive electrode active material), is preferably not more than 6.0. If (the particle diameter of the negative electrode active material/the particle diameter of the positive electrode active material) gives an excessively large value, the sum of the interface barrier energies tends to be excessively small.

[3. Nonaqueous Electrolyte Secondary Battery Separator]

The nonaqueous electrolyte secondary battery separator in accordance with an embodiment of the present invention includes a polyolefin porous film. The description below may simply use the term “porous film” to refer to a polyolefin porous film.

The porous film may by itself serve as a nonaqueous electrolyte secondary battery separator. The porous film itself can also be a base material of a nonaqueous electrolyte secondary battery laminated separator in which a porous layer (described later) is disposed on the porous film. The porous film contains polyolefin-based resin as a main component and has a large number of pores connected to one another, and allows a gas and a liquid to pass therethrough from one surface to the other.

The nonaqueous electrolyte secondary battery separator in accordance with an embodiment of the present invention may be provided with a porous layer (described later) that contains a polyvinylidene fluoride-based resin and is disposed on at least one surface of the nonaqueous electrolyte secondary battery separator. This laminated body, in which the porous layer is disposed on at least one surface of the nonaqueous electrolyte secondary battery separator, is referred to in the present specification as a “nonaqueous electrolyte secondary battery laminated separator” or a “laminated separator”. Further, the nonaqueous electrolyte secondary battery separator in accordance with an embodiment of the present invention may include, in addition to a polyolefin porous film, another layer(s) such as an adhesive layer, a heat-resistant layer, and/or a protective layer.

The porous film contains a polyolefin at a proportion of not less than 50% by volume, preferably not less than 90% by volume, more preferably not less than 95% by volume, relative to the entire porous film. The polyolefin preferably contains a high molecular weight component having a weight-average molecular weight within a range of 5×10⁵ to 15×10⁶. In particular, the polyolefin more preferably contains a high molecular weight component having a weight-average molecular weight of not less than 1,000,000 because such a polyolefin allows the nonaqueous electrolyte secondary battery separator to have a higher strength.

Specific examples of the polyolefin (thermoplastic resin) include a homopolymer or a copolymer each produced by (co)polymerizing a monomer such as ethylene, propylene, 1-butene, 4-methyl-1-pentene, or 1-hexene. Examples of the homopolymer include polyethylene, polypropylene, and polybutene. Examples of the copolymer include an ethylene-propylene copolymer.

Among the above examples, polyethylene is preferable as it is capable of preventing (shutting down) a flow of an excessively large electric current at a lower temperature. Examples of the polyethylene include low-density polyethylene, high-density polyethylene, linear polyethylene (ethylene-a-olefin copolymer), and ultra-high molecular weight polyethylene having a weight-average molecular weight of not less than 1,000,000. Among these examples, ultra-high molecular weight polyethylene having a weight-average molecular weight of not less than 1,000,000 is further preferable.

The porous film has a film thickness of preferably 4 μm to 40 μm, more preferably 5 μm to 30 μm, still more preferably 6 μm to 15 μm.

The porous film only needs to have a weight per unit area which weight is appropriately determined in view of the strength, film thickness, weight, and handleability of the porous film. Specifically, the weight per unit area of the porous film is preferably 4 g/m² to 20 g/m², more preferably 4 g/m² to 12 g/m², and still more preferably 5 g/m² to 10 g/m² so as to allow a nonaqueous electrolyte secondary battery to have a higher weight energy density and a higher volume energy density.

The porous film has an air permeability of preferably 30 sec/100 mL to 500 sec/100 mL, more preferably 50 sec/100 mL to 300 sec/100 mL, in terms of Gurley values. A porous film having an air permeability within the above range can have sufficient ion permeability.

The porous film has a porosity of preferably 20% by volume to 80% by volume, more preferably 30% by volume to 75% by volume, so as to (i) retain a larger amount of electrolyte and (ii) obtain the function of reliably preventing (shutting down) a flow of an excessively large electric current at a lower temperature. Further, in order to obtain sufficient ion permeability and prevent particles from entering the positive electrode and/or the negative electrode, the porous film has pores each having a diameter of preferably not larger than 0.3 μm, more preferably not larger than 0.14 μm.

The porous film has a puncture strength of preferably not less than 3 N, in terms of preventing short circuiting of the positive and negative electrodes, which short circuiting can occur due to the porous film being punctured by (i) particles of the positive or negative electrode active material which have fallen off from the electrodes (positive electrode or negative electrode) or (ii) a conductive foreign substance which may have gotten inside the battery. The porous base film has a puncture strength of preferably not more than 10 N, more preferably not more than 8 N.

(Parameter X)

A polyolefin porous film in accordance with an embodiment of the present invention has a parameter X whose value is not more than 20, more preferably not more than 19, and still more preferably not more than 18, the parameter X being expressed by Formula (3) below and indicating anisotropy of tan δ obtained by dynamic viscoelasticity measurement at a frequency of 10 Hz and a temperature of 90° C.

X=100×|MD tan δ−TD tan δ|/{(MD tan δ+TD tan δ)/2} (3)
where MD tan δ is tan δ in a machine direction (MD; flow direction) of the porous film, and TD tan δ is tan δ in a transverse direction (TD; width direction) of the porous film.

The parameter X indicates anisotropy of tan δ, the tan δ being calculated via the following Formula (3a), where E′ represents a storage modulus, and E″ represents a loss modulus, as measured via a dynamic viscoelasticity measurement.

tan δ=E″/E′ (3a)
The storage modulus indicates reversible deformability under stress, and the loss modulus indicates non-reversible deformability under stress. As such, tan δ indicates followability of deformation of a porous film with respect to a change in external stress. A porous film having a smaller amount of in-plane anisotropy of tan δ has more isotropic deformation followability with respect to a change in external stress, so that the porous film can more homogeneously deform in a surface direction thereof.

Configuring the polyolefin porous film in accordance with an embodiment of the present invention to have the parameter X of not more than 20 provides the porous film with isotropic deformation followability, with respect to a change in external stress occurring due to expansion and shrinkage of the electrode plates (electrode active material layer) as charge and discharge cycles are repeated. As a result, stress which occurs in the porous film as a result of the external stress becomes less anisotropic. It is considered that this makes it possible to prevent, for example, electrode active material from falling off during a charge and discharge cycle and, as a result, prevents degradation of the electrode plates after charge-discharge cycles.

Note that in a case where a porous film is provided with a porous layer or another layer each disposed on the porous film, the physical property values of the porous film, which is included in a laminated separator including the porous film and a porous layer or another layer, can be measured after the porous layer or other layer is removed from the laminated separator. The porous layer or other layer can be removed from the laminated separator by, for example, a method of dissolving the resin of the porous layer or other layer with use of a solvent such as N-methylpyrrolidone or acetone for removal.

(Method of Producing Porous Film]

For example, a porous film containing (i) ultra-high molecular weight polyolefin and (ii) a low molecular weight hydrocarbon having a weight-average molecular weight of not more than 10,000, is preferably produced by a method as described below.

Specifically, the porous film can be obtained by a method including the steps of (1) obtaining a polyolefin resin composition by kneading (i) ultra-high molecular weight polyolefin, (ii) a low molecular weight hydrocarbon having a weight-average molecular weight of not more than 10,000, and (iii) a pore forming agent, (2) forming (rolling) a sheet with use of reduction rollers to roll the polyolefin resin composition obtained in the step (1), (3) removing the pore forming agent from the sheet obtained in the step (2), and (4) obtaining a porous film by stretching the sheet obtained in the step (3). Note that the stretching of the sheet in the step (4) can be carried out before the removal of the pore forming agent from the sheet in the step (3).

A factor that determines tan δ can be a crystal structure of a polymer. Detailed research has been carried out on a relationship between tan δ and a crystal structure of polyolefin, particularly of polyethylene (see Takayanagi M., J. of Macromol. Sci.-Phys., 3, 407-431 (1967); or Koubunshigakkai-hen [edited by the Society of Polymer Science], “Koubunshikagaku no Kiso [Fundamental Polymer Science],” 2nd. Ed., Tokyo Kagaku Dojin, 1994). According to these documents, a peak of tan δ of polyethylene which peak is observed at 0° C. to 130° C. belongs to crystal relaxation (ac relaxation) and is viscoelastic crystal relaxation involved in anharmonicity of crystal lattice vibration. In a temperature range of the crystal relaxation, crystals are viscoelastic, and internal friction generated while a molecular chain is being stretched out from a lamellar crystal causes viscosity (loss elasticity). That is, it is considered that anisotropy of tan δ reflects not merely crystal anisotropy but rather anisotropy of internal friction generated while a molecular chain is being stretched out from a lamellar crystal. As such, controlling a crystalline and amorphous distribution so that the distribution is made more uniform reduces anisotropy of tan δ and thus makes it possible to produce a porous film in which the parameter X has a value of not more than 20.

Specifically, in the step (1) (described earlier), two-stage preparation is preferably carried out in which raw materials such as the ultra-high molecular weight polyolefin and the low molecular weight hydrocarbon are mixed first with use of, for example, a Henschel mixer, and then mixing is carried out again with the pore forming agent added to the mixture of the raw materials. In other words, two-stage mixing is preferably carried out in which first stage mixing is carried out before the addition of the pore forming agent, and second stage mixing is carried out after the addition of the pore forming agent. This may cause a phenomenon called gelation in which the pore forming agent and the low molecular weight hydrocarbon are uniformly coordinated around the ultra-high molecular weight polyolefin. A resin composition in which gelation has occurred allows uniform kneading of an ultra-high molecular weight polyolefin in a subsequent step and consequently facilitates uniform crystallization. This causes the crystalline and amorphous distribution to be more uniform, so that anisotropy of tan δ can be reduced. Note that in a case where the porous film is to contain an antioxidant, it is preferable to mix the antioxidant in the porous film during the first stage mixing.

In the first stage mixing, the ultra-high molecular weight polyolefin and the low molecular weight hydrocarbon are preferably uniformly mixed. It can be determined from, for example, an increase in bulk density of the mixture that the ultra-high molecular weight polyolefin and the low molecular weight hydrocarbon are uniformly mixed. Note that after the first stage mixing, the pore forming agent is preferably added after an interval of not less than 1 minute.

Note also that it can be determined from an increase in bulk density of the mixture that gelation has occurred during the mixing.

In the step (4) (described earlier), the porous film is preferably subjected to an annealing (heat fixation) treatment after the stretching. After the stretching, the porous film has (i) a region in which orientational crystallization has been caused by the stretching and (ii) the other amorphous region in which polyolefin molecules are entangled. The annealing treatment causes an amorphous part of the porous film to be reconstructed (clustered). This solves the problem of mechanical nonuniformity in a micro region of the porous film.

The annealing temperature, which is set in consideration of mobility of molecules of polyolefin to be used, is preferably not lower than (Tm −30° C.), more preferably not lower than (Tm −20° C.), still more preferably not lower than (Tm −10° C.), where Tm is the melting point of the polyolefin contained in the porous film after the stretching. A low annealing temperature will prevent the reconstruction of the amorphous region from sufficiently progressing. This may cause a failure to solve the problem of mechanical nonuniformity. Meanwhile, an annealing temperature exceeding Tm will cause melting of the polyolefin and pore blockage in the porous film, so the porous film cannot be annealed at such a temperature.

Therefore, the annealing temperature is preferably lower than Tm. The melting point Tm of the polyolefin can be measured by differential scanning calorimetry (DSC) with respect to the porous film.

The ultra-high molecular weight polyolefin which serves as a raw material of the porous film is preferably in a powder form. Examples of the low molecular weight hydrocarbon include low molecular weight polyolefin such as polyolefin wax and low molecular weight polymethylene such as Fischer-Tropsch wax. The low molecular weight polyolefin and the low molecular weight polymethylene each have a weight-average molecular weight of preferably not less than 200 and not more than 3,000. A low molecular weight hydrocarbon having a weight-average molecular weight falling within the above range is preferable. This is because (i) a low molecular weight hydrocarbon having a weight-average molecular weight of not less than 200 involves no risk of evaporation during production of the porous film, and (ii) a low molecular weight hydrocarbon having a weight-average molecular weight of not more than 3,000 can be more uniformly mixed with the ultra-high molecular weight polyolefin.

Examples of the pore forming agent include an inorganic filler and a plasticizer. The inorganic filler can be (i) an inorganic filler that is soluble in an aqueous acidic solvent, (ii) an inorganic filler that is soluble in an aqueous alkaline solvent, or (iii) an inorganic filler that is soluble in an aqueous solvent mainly composed of water.

Examples of the inorganic filler that is soluble in an aqueous acidic solvent include calcium carbonate, magnesium carbonate, barium carbonate, zinc oxide, calcium oxide, aluminum hydroxide, magnesium hydroxide, calcium hydroxide, and calcium sulfate. Of these inorganic fillers, calcium carbonate is preferable in terms of easiness to obtain a fine powder thereof at low cost. Examples of the inorganic filler that is soluble in an aqueous alkaline solvent include silicic acid and zinc oxide. Of these inorganic fillers, silicic acid is preferable in terms of easiness to obtain a fine powder thereof at low cost. Examples of the inorganic filler that is soluble in an aqueous solvent mainly composed of water include calcium chloride, sodium chloride, and magnesium sulfate.

Examples of the plasticizer include low molecular weight nonvolatile hydrocarbon compounds such as liquid paraffin and mineral oil.

[4. Porous Layer]

For an embodiment of the present invention, the porous layer is disposed, as a member of a nonaqueous electrolyte secondary battery, between (i) the nonaqueous electrolyte secondary battery separator and (ii) at least one of the positive electrode plate and the negative electrode plate. The porous layer may be present on one surface or both surfaces of the nonaqueous electrolyte secondary battery separator. The porous layer may alternatively be disposed on an active material layer of at least one of the positive electrode plate and the negative electrode plate. The porous layer may alternatively be provided between the nonaqueous electrolyte secondary battery separator and at least one of the positive electrode plate and the negative electrode plate in such a manner as to be in contact with the nonaqueous electrolyte secondary battery separator and the at least one of the positive electrode plate and the negative electrode plate. There may be a single porous layer or two or more porous layers between the nonaqueous electrolyte secondary battery separator and at least one of the positive electrode plate and the negative electrode plate.

The porous layer is preferably an insulating porous layer.

It is preferable that a resin that may be contained in the porous layer be insoluble in the electrolyte of the battery and be electrochemically stable when the battery is in normal use. In a case where the porous layer is disposed on one surface of the porous film, the porous layer is preferably disposed on that surface of the porous film which surface faces the positive electrode plate of the nonaqueous electrolyte secondary battery, more preferably on that surface of the porous film which surface comes into contact with the positive electrode plate.

The porous layer in an embodiment of the present invention contains a polyvinylidene fluoride-based resin (PVDF-based resin), the PVDF-based resin containing a

PVDF-based resin having crystal form a (hereinafter referred to as an α-form PVDF-based resin) in an amount of not less than 35.0 mol % relative to 100 mol % of the combined amount of the α-form PVDF-based resin and a PVDF-based resin having crystal form β (hereinafter, referred to as a β-form PVDF-based resin) contained in the PVDF-based resin.

Note here that the content of the α-form PVDF-based resin is calculated by (i) waveform separation of (α/2) observed at around −78 ppm in a ¹⁹F-NMR spectrum obtained from the porous layer and (ii) waveform separation of {(α/2)+β} observed at around −95 ppm in the ¹⁹F-NMR spectrum obtained from the porous layer.

The porous layer contains a large number of pores connected to one another, and thus allows a gas or a liquid to pass therethrough from one surface to the other.

Examples of the PVDF-based resin include homopolymers of vinylidene fluoride, copolymers of vinylidene fluoride and other monomer(s) copolymerizable with vinylidene fluoride, and mixtures of the above polymers. Examples of the monomer copolymerizable with vinylidene fluoride include hexafluoropropylene, tetrafluoroethylene, trifluoroethylene, trichloroethylene, and vinyl fluoride. The present invention can use (i) one kind of monomer or (ii) two or more kinds of monomers selected from above. The PVDF-based resin can be synthesized through emulsion polymerization or suspension polymerization.

The PVDF-based resin contains vinylidene fluoride at a proportion of normally not less than 85 mol %, preferably not less than 90 mol %, more preferably not less than 95 mol %, further preferably not less than 98 mol %. A PVDF-based resin containing vinylidene fluoride at a proportion of not less than 85 mol % is more likely to allow a porous layer to have a mechanical strength against pressure and a heat resistance against heat during battery production.

The porous layer can also preferably contain two kinds of PVDF-based resins that differ from each other in terms of, for example, the hexafluoropropylene content. Examples of such a porous layer includes a porous layer containing two kinds of PVDF-based resins (i.e., a first resin and a second resin) below.

The first resin is (i) a vinylidene fluoride-hexafluoropropylene copolymer containing hexafluoropropylene at a proportion of more than 0 mol % and not more than 1.5 mol % or (ii) a vinylidene fluoride homopolymer.

The second resin is a vinylidene fluoride-hexafluoropropylene copolymer containing hexafluoropropylene at a proportion of more than 1.5 mol %.

A porous layer containing the two kinds of PVDF-based resins adheres better to an electrode than a porous layer not containing one of the two kinds of PVDF-based resins. Further, a porous layer containing the two kinds of PVDF-based resins adheres better to another layer (for example, the porous film layer) included in a nonaqueous electrolyte secondary battery separator than a porous layer not containing one of the two kinds of PVDF-based resins, with the result of a higher peel strength between the two layers. The first resin and the second resin preferably have a mass ratio of 15:85 to 85:15.

The PVDF-based resin has a weight-average molecular weight of preferably 200,000 to 3,000,000, more preferably 200,000 to 2,000,000, even more preferably 500,000 to 1,500,000. A PVDF-based resin having a weight-average molecular weight of not less than 200,000 tends to allow a porous layer and an electrode to adhere to each other sufficiently. A PVDF-based resin having a weight-average molecular weight of not more than 3,000,000 tends to allow for excellent shaping easiness.

The porous layer in accordance with an embodiment of the present invention may contain a resin other than the PVDF-based resin. Examples of the other resin include: a styrene-butadiene copolymer; homopolymers or copolymers of vinyl nitriles such as acrylonitrile and methacrylonitrile; and polyethers such as polyethylene oxide and polypropylene oxide.

(Filler)

The porous layer in accordance with an embodiment of the present invention may contain a filler. The filler may be a filler such as an inorganic filler (for example, fine metal oxide particles) or an organic filler. The filler is contained at a proportion of preferably not less than 1% by mass and not more than 99% by mass, more preferably not less than 10% by mass and not more than 98% by mass, relative to the combined amount of the PVDF-based resin and the filler. The proportion of the filler may have a lower limit of not less than 50% by mass, not less than 70% by mass, or not less than 90% by mass. The filler such as the organic or inorganic filler may be a conventionally publicly known filler.

The porous layer in accordance with an embodiment of the present invention has an average thickness of preferably 0.5 μm to 10 μm, more preferably 1 μm to 5 μm, per layer in order to ensure adhesion to an electrode and a high energy density.

A porous layer having a film thickness of not less than 0.5 μm per layer can (i) reduce the possibility of internal short circuiting and (ii) retain a sufficient amount of electrolyte. This tends to improve battery characteristics.

If the porous layer has a thickness of more than 10 μm per layer, the nonaqueous electrolyte secondary battery will have an increased resistance to permeation of lithium ions. Thus, repeating charge-and-discharge cycles will degrade the positive electrode of the nonaqueous electrolyte secondary battery, with the result of a degraded rate characteristic and a degraded cycle characteristic. Further, such a porous layer will increase the distance between the positive electrode and the negative electrode, with the result of a decrease in the internal capacity efficiency of the nonaqueous electrolyte secondary battery.

The porous layer in accordance with an embodiment of the present invention is preferably disposed between the nonaqueous electrolyte secondary battery separator and the positive electrode active material layer of the positive electrode plate. The descriptions below of the physical properties of the porous layer are at least descriptions of the physical properties of a porous layer disposed between the nonaqueous electrolyte secondary battery separator and the positive electrode active material layer of the positive electrode plate in a nonaqueous electrolyte secondary battery.

The porous layer only needs to have a weight per unit area (per layer) which weight is determined as appropriate in view of the strength, thickness, weight, and handleability of the porous layer. Note, however, that the porous layer has a weight per unit area of preferably 0.5 g/m² to 20 g/m² per layer, more preferably 0.5 g/m² to 10 g/m² per layer, so as to allow a nonaqueous electrolyte secondary battery including the porous layer to have a higher weight energy density and a higher volume energy density. If the weight per unit area of the porous layer is beyond the above range, a nonaqueous electrolyte secondary battery including the porous layer will be heavy.

The porous layer contains a component(s) in a volume per square meter (i.e., a component volume per unit area (per layer)) within a range of preferably 0.5 cm³ to 20 cm³, more preferably 1 cm³ to 10 cm³, further preferably 2 cm³ to 7 cm³.

The porous layer having the component volume per unit area which component volume falls within the above numerical range allows a nonaqueous electrolyte secondary battery including the porous layer to have a higher weight energy density and a higher volume energy density. If the component volume per unit area of the porous layer is beyond the above range, the nonaqueous electrolyte secondary battery will be heavy.

The porous layer has a porosity of preferably 20% by volume to 90% by volume, more preferably 30% by volume to 80% by volume, in order to achieve sufficient ion permeability. The pore diameter of the pores in the porous layer is preferably not more than 1.0 μm, more preferably not more than 0.5 μm. In a case where the pores each have such a pore diameter, a nonaqueous electrolyte secondary battery that includes the porous layer can achieve sufficient ion permeability.

The nonaqueous electrolyte secondary battery laminated separator has an air permeability of preferably 30 sec/100 mL to 1000 sec/100 mL, more preferably 50 sec/100 mL to 800 sec/100 mL, in terms of Gurley values. The nonaqueous electrolyte secondary battery laminated separator, which has the above air permeability, allows the nonaqueous electrolyte secondary battery to have sufficient ion permeability.

An air permeability smaller than the above range means that the nonaqueous electrolyte secondary battery laminated separator has a high porosity and thus has a coarse laminated structure. This may result in a nonaqueous electrolyte secondary battery laminated separator having a lower strength and thus having an insufficient shape stability at high temperatures in particular. An air permeability larger than the above range may, on the other hand, prevent the nonaqueous electrolyte secondary battery laminated separator from having sufficient ion permeability and thus degrade the battery characteristics of the nonaqueous electrolyte secondary battery. (Crystal Forms of PVDF-Based Resin)

The PVDF-based resin included in the porous layer in accordance with an embodiment of the present invention is configured such that, assuming that the sum of the respective amounts of an α-form PVDF-based resin and a β-form PVDF-based resin contained in the PVDF-based resin is 100 mol %, the amount of the α-form PVDF-based resin contained in the PVDF-based resin is not less than 35.0 mol %, preferably not less than 37.0 mol %, more preferably not less than 40.0 mol %, even more preferably not less than 44.0 mol %. Further, the amount of the α-form PVDF-based resin is preferably not more than 90.0 mol %. The porous layer containing the α-form PVDF-based resin in an amount falling within the above range is suitably usable as a member of a nonaqueous electrolyte secondary battery in which degradation of electrode plates after charge-discharge cycles is prevented, in particular as a member of a nonaqueous electrolyte secondary battery laminated separator or as a member of an electrode of a nonaqueous electrolyte secondary battery.

The nonaqueous electrolyte secondary battery generates heat due to resistance inside the battery during charge and discharge, and calorific power increases as an electric current becomes higher, in other words, in a condition of higher rate. In the PVDF-based resin, a melting point of the α-form PVDF-based resin is higher than that of the β-form PVDF-based resin, and thus the α-form PVDF-based resin is less likely to cause plastic deformation by heat. It is known that the β-form PVDF-based resin is more polarizable than the α-form PVDF-based resin because the α-form PVDF-based resin has a structure in which F atoms are arranged in one side of the structure.

According to the porous layer in accordance with an embodiment of the present invention, controlling a proportion of an α-form PVDF-based resin contained in the PVDF-based resin constituting the porous layer to be not less than 35.0 mol % makes it possible to (i) decrease, for example, deformation of an internal structure of the porous layer and blockage of voids, the deformation and the blockage occurring due to deformation of the PVDF-based resin as a result of heat generated during charge and discharge operations, and (ii) prevent uneven distribution of Li ions, which uneven distribution occurs due to interaction between the Li ions and the PVDF-based resin. This consequently prevents degradation of electrode plates after charge-discharge cycles.

The α-form PVDF-based resin is arranged such that the polymer of the PVDF-based resin contains a PVDF skeleton having molecular chains including a main-chain carbon atom bonded to a fluorine atom (or a hydrogen atom) adjacent to two carbon atoms one of which is bonded to a hydrogen atom (or a fluorine atom) having a trans position and the other one of which is bonded to a hydrogen atom (or a fluorine atom) having a gauche position (positioned at an angle of 60°), wherein two or more such conformations are chained consecutively as follows:

(TGTG̅ Structure) [Math. 1]

and the molecular chains each have the following type:

TGTG̅ [Math. 2]

wherein the respective dipole moments of C-F₂ and C-H₂ bonds each have a component perpendicular to the molecular chain and a component parallel to the molecular chain.

The α-form PVDF-based resin has characteristic peaks at around −95 ppm and at around −78 ppm in a ¹⁹F-NMR spectrum.

The β-form PVDF-based resin is arranged such that the polymer of the PVDF-based resin contains a PVDF skeleton having molecular chains including a main-chain carbon atom adjacent to two carbon atoms bonded to a fluorine atom and a hydrogen atom, respectively, each having a trans conformation (TT-type conformation), that is, the fluorine atom and the hydrogen atom bonded respectively to the two carbon atoms are positioned oppositely at an angle of 180° to the direction of the carbon-carbon bond.

The β-form PVDF-based resin may be arranged such that the polymer of the PVDF-based resin contains a PVDF skeleton that has a TT-type conformation in its entirety. The β-form PVDF-based resin may alternatively be arranged such that a portion of the PVDF skeleton has a TT-type conformation and that the β-form PVDF-based resin has a molecular chain of the TT-type conformation in at least four consecutive PVDF monomeric units. In either case, (i) the carbon-carbon bond, in which the TT-type conformation constitutes a TT-type main chain, has a planar zigzag structure, and (ii) the respective dipole moments of C-F₂ and C-H₂ bonds each have a component perpendicular to the molecular chain.

The β-form PVDF-based resin has characteristic peaks at around -95 ppm in a ¹⁹F-NMR spectrum.

(Method for calculating content rates of α-form PVDF-based resin and β-form PVDF-based resin in PVDF-based resin)

The rate of content of the α-form PVDF-based resin and the rate of content of the β-form PVDF-based resin in the porous layer in accordance with an embodiment of the present invention relative to 100 mol % of the combined content of the α-form PVDF-based resin and the β-form PVDF-based resin may be calculated from a ¹⁹F-NMR spectrum obtained from the porous layer. The content rates are specifically calculated as follows, for example:
(1) A ¹⁹F-NMR spectrum is obtained from a porous layer containing a PVDF-based resin, under the following conditions.

### Measurement Conditions

Measurement device: AVANCE400 manufactured by Bruker Biospin

Measurement method: single-pulse method

Observed nucleus: ¹⁹F

Spectral bandwidth: 100 kHz

Pulse width: 3.0 s (90° pulse)

Pulse repetition time: 5.0 s

Reference material: C₆F₆ (external reference: -163.0 ppm)

Temperature: 22° C.

Sample rotation frequency: 25 kHz
(2) An integral value of a peak at around −78 ppm in the ¹⁹F-NMR spectrum obtained in (1) is calculated and is regarded as an α/2 amount.
(3) As with the case of (2), an integral value of a peak at around −95 ppm in the ¹⁹F-NMR spectrum obtained in (1) is calculated and is regarded as an {(α/2)+β} amount.
(4) Assuming that the sum of (i) the content of the α-form PVDF-based resin and (ii) the content of the β-form PVDF-based resin is 100 mol %, the rate of content of the α-form PVDF-based resin (hereinafter referred to also as “α rate”) is calculated from the integral values of (2) and (3) in accordance with the following Formula (4):

α rate (mol %)=[(integral value at around −78 ppm)×2/{(integral value at around −95 ppm)+(integral value at around −78 ppm)}]×100 (4)
(5) Assuming that the sum of (i) the content of the α-form PVDF-based resin and (ii) the content of the β-form PVDF-based resin is 100 mol %, the rate of content of the β-form PVDF-based resin (hereinafter referred to also as “β rate”) is calculated from the value of thea rate obtained in (4) in accordance with the following Formula (5):

β rate (mol %)=100 (mol %)−α rate (mol %) (5)

(Method for Producing Porous Layer and Nonaqueous Electrolyte Secondary Battery Laminated Separator)

A method for producing each of the porous layer and the nonaqueous electrolyte secondary battery laminated separator in accordance with an embodiment of the present invention is not limited in particular, and any of various production methods may be employed.

According to the nonaqueous electrolyte secondary battery laminated separator, for example, a porous layer containing a PVDF-based resin and optionally a filler is formed through one of the processes (1) to (3) below on a surface of a porous film that serves as a base material of a nonaqueous electrolyte secondary battery separator. In the case of the process (2) or (3), a porous layer deposited is dried for removal of the solvent. In the case of production of a porous layer containing a filler, the coating solution in the processes (1) through (3) preferably contains a filler dispersed therein and a PVDF-based resin dissolved therein.

The coating solution for use in a method for producing a porous layer in accordance with an embodiment of the present invention can be prepared typically by (i) dissolving, in a solvent, a resin to be contained in the porous layer and, (ii) in a case where a filler is to be contained in the porous layer, dispersing the filler in the solvent.

(1) A process of (i) coating a surface of a porous film with a coating solution containing a PVDF-based resin to be contained in the porous layer and optionally a filler and (ii) drying the surface of the porous film to remove the solvent (dispersion medium) from the coating solution for formation of a porous layer.

(2) A process of (i) coating a surface of a porous film with the coating solution described in (1) and then (ii) immersing the porous film into a deposition solvent (which is a poor solvent for the PVDF-based resin) for deposition of a porous layer.

(3) A process of (i) coating a surface of a porous film with the coating solution described in (1) and then (ii) making the coating solution acidic with use of a low-boiling-point organic acid for deposition of a porous layer.

Examples of the solvent (dispersion medium) in the coating solution include N-methylpyrrolidone, N,N-dimethylacetamide, N,N-dimethylformamide, acetone, and water.

The deposition solvent is preferably isopropyl alcohol or t-butyl alcohol, for example.

For the process (3), the low-boiling-point organic acid can be, for example, paratoluene sulfonic acid or acetic acid.

The coating solution may contain an additive(s) as appropriate such as a dispersing agent, a plasticizing agent, a surface active agent, and a pH adjusting agent as a component(s) other than the resin and the filler.

The base material can be, other than a porous film, another film, a positive electrode plate, a negative electrode plate, or the like.

The coating solution can be applied to the base material by a conventionally publicly known method. Specific examples of such a method include a gravure coater method, a dip coater method, a bar coater method, and a die coater method.

(Method for Controlling Crystal Forms of PVDF-Based Resin)

The crystal form of the PVDF-based resin contained in the porous layer in accordance with an embodiment of the present invention can be controlled on the basis of (i) drying conditions such as the drying temperature, and the air velocity and air direction during drying in the above described method and (ii) the deposition temperature at which a porous layer containing a PVDF-based resin is deposited with use of a deposition solvent or a low-boiling-point organic acid.

In a case where the coating solution is simply dried as in the process (1), the drying conditions may be changed as appropriate by adjusting, for example, the amount of the solvent in the coating solution, the concentration of the PVDF-based resin in the coating solution, the amount of the filler (if contained), and/or the amount of the coating solution to be applied. In a case where a porous layer is to be formed through the above process (1), it is preferable that the drying temperature be 30° C. to 100° C., that the direction of hot air for drying be perpendicular to a nonaqueous electrolyte secondary battery separator or electrode plate to which the coating solution has been applied, and that the velocity of the hot air be 0.1 m/s to 40 m/s. Specifically, in a case where a coating solution to be applied contains N-methyl-2-pyrrolidone as the solvent for dissolving a PVDF-based resin, 1.0% by mass of a PVDF-based resin, and 9.0% by mass of alumina as an inorganic filler, the drying conditions are preferably adjusted so that the drying temperature is 40° C. to 100° C., that the direction of hot air for drying is perpendicular to a nonaqueous electrolyte secondary battery separator or an electrode plate to which the coating solution has been applied, and that the velocity of the hot air is 0.4 m/s to 40 m/s.

In a case where a porous layer is to be formed through the above process (2), it is preferable that the deposition temperature be −25° C. to 60° C. and that the drying temperature be 20° C. to 100° C. Specifically, in a case where a porous layer is to be formed through the above process (2) with use of N-methylpyrrolidone as the solvent for dissolving a PVDF-based resin and isopropyl alcohol as the deposition solvent, it is preferable that the deposition temperature be −10° C. to 40° C. and that the drying temperature be 30° C. to 80° C.

(Another Porous Layer)

The nonaqueous electrolyte secondary battery in accordance with an embodiment of the present invention can contain another porous layer in addition to (i) the porous film and (ii) the porous layer containing the PVDF-based resin. The another porous layer need only be provided between (i) the nonaqueous electrolyte secondary battery separator and (ii) at least one of the positive electrode plate and the negative electrode plate. The porous layer and the another porous layer may be provided in any order with respect to the nonaqueous electrolyte secondary battery separator. In a preferable configuration, the porous film, the another porous layer, and the porous layer containing the PVDF-based resin are disposed in this order. In other words, the another porous layer is provided between the porous film and the porous layer containing the PVDF-based resin. In another preferable configuration, the another porous layer and the porous layer containing the PVDF-based resin are provided in this order on both surfaces of the porous film.

Examples of a resin which can be contained in the another porous layer in accordance with an embodiment of the present invention encompass: polyolefins; (meth)acrylate-based resins; fluorine-containing resins (excluding polyvinylidene fluoride-based resins); polyamide-based resins; polyimide-based resins; polyester-based resins; rubbers; resins with a melting point or glass transition temperature of not lower than 180° C.; water-soluble polymers; polycarbonate, polyacetal, and polyether ether ketone.

Among the above resins, polyolefins, (meth)acrylate-based resins, polyamide-based resins, polyester-based resins, and water-soluble polymers are preferable.

Preferable examples of the polyolefin encompass polyethylene, polypropylene, polybutene, and an ethylene-propylene copolymer.

Examples of the fluorine-containing resins encompass polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer. Particular examples of the fluorine-containing resins encompass fluorine-containing rubber having a glass transition temperature of not higher than 23° C.

Preferable examples of the polyamide-based resin encompass aramid resins such as aromatic polyamide and wholly aromatic polyamide.

Specific examples of the aramid resin encompass poly(paraphenylene terephthalamide), poly(methaphenylene isophthalamide), poly(parabenzamide), poly(metabenzamide), poly(4,4′ -benzanilide terephthalamide), poly(paraphenylene-4,4′ -biphenylene dicarboxylic acid amide), poly(methaphenylene-4,4′-biphenylene dicarboxylic acid amide), poly(paraphenylene-2,6-naphthalene dicarboxylic acid amide), poly(methaphenylene-2,6-naphthalene dicarboxylic acid amide), poly(2-chloroparaphenylene terephthalamide), a paraphenylene terephthalamide/2,6-dichloroparaphenylene terephthalamide copolymer, and a methaphenylene terephthalamide/2,6-dichloroparaphenylene terephthalamide copolymer. Among these aramid resins, poly(paraphenylene terephthalamide) is more preferable.

Preferable examples of the polyester-based resin encompass (i) aromatic polyesters such as polyarylate and (ii) liquid crystal polyesters.

Examples of the rubbers encompass a styrene-butadiene copolymer and a hydride thereof, a methacrylic acid ester copolymer, an acrylonitrile-acrylic acid ester copolymer, a styrene-acrylic acid ester copolymer, an ethylene propylene rubber, and polyvinyl acetate.

Examples of the resin with a melting point or a glass transition temperature of not lower than 180° C. encompass polyphenylene ether, polysulfone, polyether sulfone, polyphenylene sulfide, polyetherimide, polyamide imide, and polyether amide.

Examples of the water-soluble polymer encompass polyvinyl alcohol, polyethylene glycol, cellulose ether, sodium alginate, polyacrylic acid, polyacrylamide, and polymethacrylic acid.

Only one kind of these resins to be contained in the another porous layer can be used, or two or more kinds of these resins can be used in combination.

The other characteristics (e.g., thickness) of the another porous layer are similar to the characteristics described in Section [4. Porous layer] above, except that the porous layer contains the PVDF-based resin.

[5. Nonaqueous Electrolyte]

A nonaqueous electrolyte that can be contained in the nonaqueous electrolyte secondary battery in accordance with an embodiment of the present invention is not limited to any particular one, provided that the nonaqueous electrolyte is one that is generally used for a nonaqueous electrolyte secondary battery. The nonaqueous electrolyte can be a nonaqueous electrolyte containing, for example, an organic solvent and a lithium salt dissolved therein. Examples of the lithium salt encompass LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAl Cl₄. It is possible to use only one kind of the above lithium salts or two or more kinds of the above lithium salts in combination.

Examples of the organic solvent to be contained in the nonaqueous electrolyte encompass carbonates, ethers, esters, nitriles, amides, carbamates, and sulfur-containing compounds, and fluorine-containing organic solvents each obtained by introducing a fluorine group into any of these organic solvents. It is possible to use only one kind of the above organic solvents or two or more kinds of the above organic solvents in combination.

[6. Method for Producing Nonaqueous Electrolyte Secondary Battery]

The nonaqueous electrolyte secondary battery in accordance with an embodiment of the present invention can be produced by, for example, (i) forming a nonaqueous electrolyte secondary battery member in which the positive electrode plate, the nonaqueous electrolyte secondary battery laminated separator, and the negative electrode plate are arranged in this order, (ii) then inserting the nonaqueous electrolyte secondary battery member into a container for use as a housing of the nonaqueous electrolyte secondary battery, (iii) then filling the container with a nonaqueous electrolyte, and (iv) then hermetically sealing the container under reduced pressure.

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

[Method for Measuring Various Physical Properties]

In the Examples and Comparative Examples, measurements were made by the methods below.

(1) Untamped Density (Resin Composition)

The untamped density of a resin composition used to produce a porous film was measured in conformity with JIS R9301-2-3.

(2) Dynamic Viscoelasticity (Porous Film)

The dynamic viscoelasticity of the porous film was measured with use of a dynamic viscoelasticity measurement device (itk DVA-225, available from ITK Co., Ltd.) at a frequency of 10 Hz and a temperature of 90° C.

Specifically, a test piece that (i) had been cut out from a porous film so as to be strip-shaped and that (ii) had a width of 5 mm, assuming that MD was the longitudinal direction, was used to measure tan δ in the MD while the chuck-to-chuck distance was set at 20 mm and a tension of 30 cN was applied to the test piece. Similarly, a test piece that (i) had been cut out from the porous film so as to be strip-shaped and that (ii) had a width of 5 mm, assuming that TD was the longitudinal direction, was used to measure tan δ in the TD while the chuck-to-chuck distance was set at 20 mm and a tension of 30 cN was applied to the test piece. The measurement was carried out while the temperature was raised at a rate of 20° C./min from room temperature. The parameter X was calculated on the basis of tan δ measured when the temperature reached 90° C.

(3) Puncture Strength with Respect to a Weight Per Unit Area (Porous Film)

A porous film was fixed with a washer having a diameter of 12 mm by use of a handy-type compression tester (model No. KES-G5, available from KATO TECH CO., LTD.). The puncture strength (unit: gf/g/m²) of the porous film was defined as the maximum stress (gf) obtained when the porous film material was punctured with a pin at 200 mm/min. The pin used had a pin diameter of 1 mm and a tip radius of 0.5 R.

(4) Measurement of Melting Point (Porous Film)

Approximately 50 mg of a porous film was placed in an aluminum pan, and then a DSC thermogram was obtained with use of a differential scanning calorimeter (EXSTAR6000, available from Seiko Instruments Inc.) while the temperature was raised at a rate of 20° C./min. The peak temperature of a melting peak around 140° C. was assumed as Tm.

(5) Rate of Content of α-Form PVDF-Based Resin (Porous Layer)

A piece with a size of approximately 2 cm×5 cm was cut out from each of the laminated porous films produced in the Examples and Comparative Examples below. Then, the rate of content (a rate) of the α-form PVDF-based resin in the PVDF-based resin contained in the cutout was measured through the above steps (1) to (4) described in the (Method for calculating content rates of α-form PVDF-based resin and β-form PVDF-based resin in PVDF-based resin)” section.

(6) Respective Average Particle Diameters of Positive Electrode Active Material and Negative Electrode Active Material

The volume-based particle size distribution and average particle diameter (D50) were measured with use of a laser diffraction particle size analyzer (product name: SALD2200, manufactured by Shimadzu Corporation).

(7) Porosity (Electrode Active Material Layer)

The porosity c of the positive electrode active material layer or negative electrode active material layer was calculated in accordance with the formula shown in the “(Positive electrode plate)” section.

(8) Sum of Interface barrier Energies

The sum of the interface barrier energies was calculated through the steps (1) to (5) described in the “(Sum of interface barrier energies)” section.

(9) Discharge Capacity Maintaining Rate at 0.2 C after 100 Cycles

A discharge capacity maintaining rate at 0.2 C after 100 cycles was measured through the steps (1) through (5) described in Section [1. Nonaqueous electrolyte secondary battery in accordance with an aspect of the present invention].

### Example 1

### [Production of Nonaqueous Electrolyte Secondary Battery Laminated Separator]

The substances (i) and (ii) below were mixed in powder form at 440 rpm for 70 seconds with use of a Henschel mixer.
(i) 70% by weight of ultra-high molecular weight polyethylene powder (GUR4032, manufactured by Ticona Corporation) and 30% by weight of polyethylene wax (FNP-0115, manufactured by Nippon Seiro Co., Ltd.) having a weight-average molecular weight of 1,000; and
(ii) 0.4 parts by weight of an antioxidant (Irg1010, manufactured by Ciba Specialty Chemicals Corporation), 0.1 parts by weight of an antioxidant (P168, manufactured by Ciba Specialty Chemicals Corporation), and 1.3 parts by weight of sodium stearate (note that a total weight of (i) is defined as 100 parts by weight).

Further, the substances (iii) below were added and were then mixed in powder form at 440 rpm for 80 seconds with use of a Henschel mixer.
(iii) 38% by volume of calcium carbonate (manufactured by Maruo Calcium Co., Ltd.) having an average particle diameter of 0.1 μm (note that a total volume of (i) through (iii) is defined as 100% by volume).

The resulting mixture, which was in powder form, had an untamped density of approximately 500 g/L. The resulting mixture in powder form was then melted and kneaded in a twin screw kneading extruder. This produced a polyolefin resin composition.

Next, the polyolefin resin composition was rolled with use of a pair of rollers each having a surface temperature of 150° C. This produced a sheet of the polyolefin resin composition. This sheet was immersed in an aqueous hydrochloric acid solution (containing 4 mol/L of hydrochloric acid and 0.5% by weight of nonionic surfactant) for removal of the calcium carbonate. Subsequently, the sheet was stretched 6.2-fold in the TD at 100° C. and was then annealed at 120° C. This produced a porous film 1. Note here that the annealing temperature of 120° C. is lower by 13° C. than 133° C., which is the melting point of the polyolefin resin contained in the sheet. The porous film 1 produced had a puncture strength of 3.6 N.

An N-methyl-2-pyrrolidone solution (manufactured by Kureha Corporation; product name: L#9305, weight-average molecular weight: 1,000,000) containing a PVDF-based resin was prepared as a coating solution. The coating solution was applied to the porous film 1. The PVDF-based resin used in the N-methyl-2-pyrrolidone solution was polyvinylidene fluoride-hexafluoropropylene copolymer. The application of the coating solution was carried out by a doctor blade method, and so that the applied coating solution was adjusted to weigh 6.0 g per square meter of the PVDF-based resin in the coating solution.

The porous film, to which the coating solution had been applied, was immersed into 2-propanol while the coating film was wet with the solvent, and was then left to stand still at −10° C. for 5 minutes in a state of being immersed into 2-propanol. This produced a laminated porous film 1. The laminated porous film 1 produced was further immersed into other 2-propanol while the laminated porous film 1 was wet with the above immersion solvent, and was then left to stand still at 25° C. for 5 minutes in a state of being immersed into the other 2-propanol. This produced a laminated porous film 1a. The laminated porous film la produced was dried at 30° C. for 5 minutes. This produced a nonaqueous electrolyte secondary battery laminated separator 1 including a porous layer. Table 1 shows results of evaluation of the porous film 1 and the nonaqueous electrolyte secondary battery laminated separator 1 produced.

[Preparation of Nonaqueous Electrolyte Secondary Battery]

(Positive Electrode Plate)

A positive electrode plate was obtained in which a positive electrode mix (LiNi_{0.5}Mn_{0.3}Co_{0.2}O₂/electrically conductive agent/PVDF (weight ratio of 92:5:3)) was disposed on one surface of a positive electrode current collector (aluminum foil). LiNi_{0.5}Mn_{0.3}Co_{0.2}O₂ had a volume-based average particle diameter (D50) of 5 μm. In the positive electrode plate thus obtained, a positive electrode active material layer had a porosity of 40%.

The positive electrode plate was partially cut off as a positive electrode plate 1 that was constituted by (i) a portion which had a size of 45 mm×30 mm and on which a positive electrode active material layer was disposed and (ii) a portion which surrounded an outer periphery of the portion of (i) and had a width of 13 mm and on which the positive electrode active material layer was not disposed.

(Negative Electrode Plate)

A negative electrode plate was obtained in which a negative electrode mix (natural graphite/styrene-1,3-butadiene copolymer/sodium carboxymethylcellulose (weight ratio of 98:1:1) was disposed on one surface of a negative electrode current collector (copper foil). The natural graphite had a volume-based average particle diameter (D50) of 15 μm. In the obtained negative electrode plate, the negative electrode active material layer had a porosity of 31%.

The negative electrode plate was partially cut off as a negative electrode plate 1 that was constituted by (i) a portion which had a size of 50 mm×35 mm and on which a negative electrode active material layer was disposed and (ii) a portion which surrounded an outer periphery of the portion of (i) and had a width of 13 mm and on which the negative electrode active material layer was not disposed.

As can be seen from the above description, with regard to the positive electrode plate 1 and the negative electrode plate 1, (the particle diameter of the negative electrode active material)/(the particle diameter of the positive electrode active material) gave 3.0. Table 1 shows the results of evaluation of the sum of the respective interface barrier energies measured of the positive electrode plate 1 and the negative electrode plate 1.

(Assembly of Nonaqueous Electrolyte Secondary Battery)

The following method was used for preparing a nonaqueous electrolyte secondary battery by using the positive electrode plate 1, the negative electrode plate 1, and the nonaqueous electrolyte secondary battery laminated separator 1.

In a laminate pouch, the positive electrode plate 1, the nonaqueous electrolyte secondary battery laminated separator 1 with the porous layer facing the positive electrode, and the negative electrode plate 1 were disposed (arranged) on top of one another so as to obtain a nonaqueous electrolyte secondary battery member 1. During this operation, the positive electrode plate 1 and the negative electrode plate 1 were arranged so that the positive electrode active material layer of the positive electrode plate 1 had a main surface that was entirely covered by the main surface of the negative electrode active material layer of the negative electrode plate 1.

Subsequently, the nonaqueous electrolyte secondary battery member 1 was put into a bag prepared in advance from a laminate of an aluminum layer and a heat seal layer. Further, 0.23 mL of nonaqueous electrolyte was put into the bag. The above nonaqueous electrolyte was prepared by dissolving LiPF₆ in a mixed solvent of ethylene carbonate, ethyl methyl carbonate, and diethyl carbonate at a ratio of 3:5:2 (volume ratio) so that the LiPF₆ would be contained at 1 mol/L. The bag was then heat-sealed while the pressure inside the bag was reduced. This produced a nonaqueous electrolyte secondary battery 1.

After that, a discharge capacity maintaining rate at 0.2 C after 100 cycles of the nonaqueous electrolyte secondary battery 1 obtained by the above described method was measured. Table 1 shows the measurement results.

### Example 2

### [Production of Nonaqueous Electrolyte Secondary Battery Laminated Separator]

The substances (i) and (ii) below were mixed in powder form at 440 rpm for 70 seconds with use of a Henschel mixer.
(i) 68.5% by weight of ultra-high molecular weight polyethylene powder (GUR4032, manufactured by Ticona Corporation) and 31.5% by weight of polyethylene wax (FNP-0115, manufactured by Nippon Seiro Co., Ltd.) having a weight-average molecular weight of 1,000; and
(ii) 0.4 parts by weight of an antioxidant (Irg1010, manufactured by Ciba Specialty Chemicals Corporation), 0.1 parts by weight of an antioxidant (P168, manufactured by Ciba Specialty Chemicals Corporation), and 1.3 parts by weight of sodium stearate (note that a total weight of (i) is defined as 100 parts by weight).

Further, the substances (iii) below were added and were then mixed in powder form at 440 rpm for 80 seconds with use of a Henschel mixer.
(iii) 38% by volume of calcium carbonate (manufactured by Maruo Calcium Co., Ltd.) having an average particle diameter of 0.1 μm (note that a total volume of (i) through (iii) is defined as 100% by volume).

The resulting mixture, which was in powder form, had an untamped density of approximately 500 g/L. The resulting mixture in powder form was then melted and kneaded in a twin screw kneading extruder. This produced a polyolefin resin composition.

Next, the polyolefin resin composition was rolled with use of a pair of rollers each having a surface temperature of 150° C. This produced a sheet of the polyolefin resin composition. This sheet was immersed in an aqueous hydrochloric acid solution (containing 4 mol/L of hydrochloric acid and 0.5% by weight of nonionic surfactant) for removal of the calcium carbonate. Subsequently, the sheet was stretched 7.0-fold in the TD at 100° C. and was then annealed at 123° C. This produced a porous film 2. Note here that the annealing temperature of 123° C. is lower by 10° C. than 133° C., which is the melting point of the polyolefin resin contained in the sheet. The porous film 2 produced had a puncture strength of 3.4 N.

A coating solution was applied to the porous film 2 in a manner similar to that of Example 1. The porous film, to which the coating solution had been applied, was immersed into 2-propanol while the coating film was wet with the solvent, and was then left to stand still at −5° C. for 5 minutes in a state of being immersed into 2-propanol. This produced a laminated porous film 2. The laminated porous film 2 produced was further immersed into other 2-propanol while the laminated porous film 2 was wet with the above immersion solvent, and was then left to stand still at 25° C. for 5 minutes in a state of being immersed into the other 2-propanol. This produced a laminated porous film 2a. The laminated porous film 2a produced was dried at 30° C. for 5 minutes. This produced a nonaqueous electrolyte secondary battery laminated separator 2 including a porous layer. Table 1 shows results of evaluation of the porous film 2 and the nonaqueous electrolyte secondary battery laminated separator 2 produced.

[Preparation of Nonaqueous Electrolyte Secondary Battery]

A nonaqueous electrolyte secondary battery was prepared in a manner similar to that of Example 1, except that the nonaqueous electrolyte secondary battery laminated separator 2 was used instead of the nonaqueous electrolyte secondary battery laminated separator 1. The nonaqueous electrolyte secondary battery thus prepared is hereinafter referred to as “nonaqueous electrolyte secondary battery 2”.

After that, a discharge capacity maintaining rate at 0.2 C after 100 cycles of the nonaqueous electrolyte secondary battery 2 obtained by the above described method was measured and calculated. Table 1 shows the measurement results.

### Example 3

(Positive Electrode Plate)

A positive electrode plate was obtained in which a positive electrode mix (LiCoO₂/electrically conductive agent/PVDF (weight ratio of 100:5:3)) was disposed on one surface of a positive electrode current collector (aluminum foil). LiCoO₂ had a volume-based average particle diameter (D50) of 13 μm. In the positive electrode plate thus obtained, a positive electrode active material layer had a porosity of 31%.

The positive electrode plate was partially cut off as a positive electrode plate 2 that was constituted by (i) a portion which had a size of 45 mm×30 mm and on which a positive electrode active material layer was disposed and (ii) a portion which surrounded an outer periphery of the portion of (i) and had a width of 13 mm and on which the positive electrode active material layer was not disposed.

As can be seen from the above description as well as the description in Example 1, with regard to the positive electrode plate 2 and the negative electrode plate 1, (the particle diameter of the negative electrode active material/the particle diameter of the positive electrode active material) gave 1.1. Table 1 shows the results of evaluation of the sum of the respective interface barrier energies measured of the positive electrode plate 2 and the negative electrode plate 1.

[Preparation of Nonaqueous Electrolyte Secondary Battery]

The positive electrode plate 2 was used as a positive electrode plate, the negative electrode plate 1 was used as a negative electrode plate, and the nonaqueous electrolyte secondary battery laminated separator 2 was used as a nonaqueous electrolyte secondary battery laminated separator. Except for those, a nonaqueous electrolyte secondary battery was prepared in a manner similar to that of Example 1. The nonaqueous electrolyte secondary battery thus prepared is hereinafter referred to as “nonaqueous electrolyte secondary battery 3”.

After that, a discharge capacity maintaining rate at 0.2 C after 100 cycles of the nonaqueous electrolyte secondary battery 3 obtained by the above described method was measured and calculated. Table 1 shows the measurement results.

### Example 4

### [Preparation of Porous Layer and Nonaqueous Electrolyte Secondary Battery Laminated Separator]

In N-methyl-2-pyrrolidone, a PVDF-based resin (product name: “Kynar (registered trademark) LBG”, available from Arkema Inc.; weight-average molecular weight of 590,000) was stirred and dissolved at 65° C. for 30 minutes. Note that the solid content in the solution after the dissolution was controlled to 10% by mass. The solution thus obtained was used as a binder solution. As a filler, alumina fine particles (manufactured by Sumitomo Chemical Co., Ltd.; product name “AKP3000”; containing 5 ppm of silicon) was used. The alumina fine particles, the binder solution, and a solvent (N-methyl-2-pyrrolidone) were mixed together in the following proportion. That is, the alumina fine particles, the binder solution, and the solvent were mixed together so that (i) a resultant mixed solution contained 10 parts by weight of the PVDF-based resin with respect to 90 parts by weight of the alumina fine particles and (ii) a solid content concentration (alumina fine particles+PVDF-based resin) of the mixed solution was 10% by weight. A dispersion solution was thus obtained. The coating solution was applied by a doctor blade method to the porous film 2 produced in Example 2 so that the applied coating solution weighed 6.0 g per square meter of the PVDF-based resin in the coating solution. This produced a laminated porous film 3. The laminated porous film 3 was dried at 65° C. for 5 minutes. This produced a nonaqueous electrolyte secondary battery laminated separator 3 including a porous layer. The drying operation involved hot air blown in an air direction perpendicular to the base material at an air velocity of 0.5 m/s. Table 1 shows the results of evaluation of the separator 3 produced.

[Preparation of Nonaqueous Electrolyte Secondary Battery]

A nonaqueous electrolyte secondary battery was prepared in a manner similar to that of Example 1, except that the nonaqueous electrolyte secondary battery laminated separator 3 was used instead of the nonaqueous electrolyte secondary battery laminated separator 1. The nonaqueous electrolyte secondary battery thus prepared is hereinafter referred to as “nonaqueous electrolyte secondary battery 4”.

After that, a discharge capacity maintaining rate at 0.2 C after 100 cycles of the nonaqueous electrolyte secondary battery 4 obtained by the above described method was measured and calculated. Table 1 shows the measurement results.

### Comparative Example 1

### Preparation of Nonaqueous Electrolyte Secondary Battery Separator

A porous film to which a coating solution had been applied as in Example 2 was immersed into 2-propanol while the coating film was wet with the solvent, and was then left to stand still at −78° C. for 5 minutes. This produced a laminated porous film 4. The laminated porous film 4 produced was further immersed into other 2-propanol while the laminated porous film 4 was wet with the above immersion solvent, and was then left to stand still at 25° C. for 5 minutes in a state of being immersed into the other 2-propanol. This produced a laminated porous film 4a. The laminated porous film 4a produced was dried at 30° C. for 5 minutes. This produced a nonaqueous electrolyte secondary battery laminated separator 4. Table shows a result of evaluation of the nonaqueous electrolyte secondary battery laminated separator 4 produced.

[Preparation of Nonaqueous Electrolyte Secondary Battery]

A nonaqueous electrolyte secondary battery was prepared in a manner similar to that of Example 1, except that the nonaqueous electrolyte secondary battery laminated separator 4 was used instead of the nonaqueous electrolyte secondary battery laminated separator 1. The nonaqueous electrolyte secondary battery thus prepared is hereinafter referred to as “nonaqueous electrolyte secondary battery 5”.

After that, a discharge capacity maintaining rate at 0.2 C after 100 cycles of the nonaqueous electrolyte secondary battery 5 obtained by the above described method was measured and calculated. Table 1 shows the measurement results.

### Comparative Example 2

(Negative Electrode Plate)

A negative electrode plate was obtained in which a negative electrode mix (artificial spherocrystal graphite/electrically conductive agent/PVDF (weight ratio of 85:15:7.5)) was disposed on one surface of a negative electrode current collector (copper foil). The artificial spherocrystal graphite had a volume-based average particle diameter (D50) of 34 μm. In the obtained negative electrode plate, the negative electrode active material layer had a porosity of 34%.

The negative electrode plate was partially cut off as a negative electrode plate 2 that was constituted by (i) a portion which had a size of 50 mm×35 mm and on which a negative electrode active material layer was disposed and (ii) a portion which surrounded an outer periphery of the portion of (i) and had a width of 13 mm and on which the negative electrode active material layer was not disposed.

As can be seen from the above description as well as the description in Example 1, with regard to the positive electrode plate 1 and the negative electrode plate 2, (the particle diameter of the negative electrode active material)/(the particle diameter of the positive electrode active material) gave 6.8. Table 1 shows the results of evaluation of the sum of the respective interface barrier energies measured of the positive electrode plate 1 and the negative electrode plate 3.

[Preparation of Nonaqueous Electrolyte Secondary Battery]

The positive electrode plate 1 was used as a positive electrode plate, the negative electrode plate 2 was used as a negative electrode plate, and the nonaqueous electrolyte secondary battery laminated separator 2 was used as a nonaqueous electrolyte secondary battery laminated separator. Except for those, a nonaqueous electrolyte secondary battery was prepared in a manner similar to that of Example 1. The nonaqueous electrolyte secondary battery thus prepared is hereinafter referred to as “nonaqueous electrolyte secondary battery 6”.

After that, a discharge capacity maintaining rate at 0.2 C after 100 cycles of the nonaqueous electrolyte secondary battery 6 obtained by the above described method was measured and calculated. Table 1 shows the measurement results.

TABLE 1

| | | | Electrode | |
|---|---|---|---|---|
| | | | plates | |
| | | | Sum of | |
| | | | respective | |
| | | | interface | |
| | | | barrier | Nonaqueous |
| | | | energies of | electrolyte |
| | Nonaqueous electrolyte | | positive | Secondary |
| | secondary battery | | electrode | battery |
| | laminated separator | | active | Discharge |
| | | Porous layer | material and | capacity |
| | | Content | negative | maintaining |
| | Porous film | of α- | electrode | rate |
| | Tan δ | form PVDF- | active | at 0.2 C after |
| | (anisotropy) | based resin | material | 100 cycles |
| | parameter X | (mol %) | (J/mol) | (%) |
| Example 1 | 15.8 | 35.3 | 9069 | 88.5 |
| Example 2 | 2.3 | 44.4 | 9069 | 84.4 |
| Example 3 | 2.3 | 44.4 | 12612 | 85.3 |
| Example 4 | 2.3 | 64.3 | 9069 | 85.5 |
| Comparative | | | | |
| Example 1 | 2.3 | 34.6 | 9069 | 83.2 |
| Comparative | | | | |
| Example 2 | 2.3 | 44.4 | 4883 | 81.9 |

(Results)

In all the Examples 1 through 4, (i) thea rate of the polyvinylidene fluoride-based resin contained in the porous layer was not less than 35.0 mol % and (ii) the sum of the interface barrier energies was not less than 5000 J/mol. Therefore, the discharge capacity maintaining rate at 0.2 C after 100 cycles was a preferable value, that is, not less than 84%.

On the other hand, Comparative Examples failed to satisfy any of the conditions. Specifically, (i) in Comparative Example 1, the a rate of the polyvinylidene fluoride-based resin contained in the porous layer was less than 35.0 mol %, and (ii) in Comparative Example 2, the sum of the interface barrier energies was less than 5000 J/mol. Consequently, in all the Comparative Examples, the discharge capacity maintaining rate at 0.2 C after 100 cycles was less than 84%.

[Referential Example: Control of Interface Barrier Energies]

A positive electrode plate and a negative electrode plate were prepared for which adjustment had been made to the particle diameter ratio between a positive electrode active material and a negative electrode active material. The sum of the respective interface barrier energies was measured. Specifically, a positive electrode plate and a negative electrode plate were prepared with respective active materials having particle diameters changed from those in Example 1 as below while the compositions of the respective electrode plates were identical to those in Example 1. Table 2 shows the results of measurement of the sum of the respective interface barrier energies of the positive electrode plate and the negative electrode plate.

Further, a nonaqueous electrolyte secondary battery was prepared as in Example 1 except that the above positive electrode plate and negative electrode plate were used. The discharge capacity maintaining rate of the nonaqueous electrolyte secondary battery at 0.2 C after 100 cycles was measured. Table 2 shows the results.

TABLE 2

| | | Average | | | |
|---|---|---|---|---|---|
| | Average | particle | | | Discharge |
| | particle | diameter of | | | capacity |
| | diameter of | negative | | Sum of | maintaining |
| | positive | electrode | | interface | rate at 0.2 C |
| | electrode | active | Particle | barrier | after 100 |
| | active material | material | diameter | energies | cycles |
| | (μm) | (μm) | ratio | (J/mol) | (%) |
| Example 1 | 5 | 15 | 3 | 9069 | 88.5 |
| Referential | 0.8 | 20.3 | 24.7 | 4228 | 83.5 |
| Example | | | | | |

(Results)

The positive electrode plate and the negative electrode plate in Example 1 were identical in composition to the positive electrode plate and the negative electrode plate in the Referential Example. The particle diameter ratio between the positive electrode active material and the negative electrode active material (a value given by (the particle diameter of the negative electrode active material/the particle diameter of the positive electrode active material)) was 3 in Example 1, but was 24.7 in the Referential Example. The sum of the respective interface barrier energies was 9069 J/mol in Example 1, but was only 4228 J/mol in the Referential Example.

These experimental results show that the sum of the interface barrier energies can be effectively controlled by, for example, adjusting the particle diameter ratio between the positive electrode active material and the negative electrode active material. It is needless to say that the sum of the interface barrier energies may be controlled by another method. The discharge capacity maintaining rate at 0.2 C after 100 cycles was 88.5% in Example 1, but was only 83.5% in the Referential Example. These experimental results more clearly show that controlling the sum of the interface barrier energies to a predetermined value is one factor in preventing degradation of the electrode plates after charge-discharge cycles.

### INDUSTRIAL APPLICABILITY

A nonaqueous electrolyte secondary battery in accordance with an aspect of the present invention prevents degradation of electrode plates after charge-discharge cycles. Therefore, the present invention is suitably applicable to (i) batteries for use in a personal computer, a mobile telephone, a portable information terminal, and the like and (ii) on-vehicle batteries.

1. A nonaqueous electrolyte secondary battery comprising:
a nonaqueous electrolyte secondary battery separator including a polyolefin porous film;
a porous layer containing a polyvinylidene fluoride-based resin;
a positive electrode plate; and
a negative electrode plate,
in a case where the positive electrode plate and the negative electrode plate have each been processed into a disk having a diameter of 15.5 mm and immersed in a solution of ethylene carbonate, ethyl methyl carbonate, and diethyl carbonate which solution contains LiPF₆ at a concentration of 1 M, a sum of respective interface barrier energies measured of a positive electrode active material and a negative electrode active material being not less than 5000 J/mol,
the polyolefin porous film having a parameter X of not more than 20, the parameter X being calculated in accordance with a formula below, where MD tan δ represents a tan δ measured in a machine direction through a viscoelasticity measurement performed at a frequency of 10 Hz and a temperature of 90° C., and TD tan δ represents a tan δ measured in a transverse direction through the viscoelasticity measurement,
X=100×|MD tan δ−TD tan δ|/{(MD tan δ+TD tan δ)/2}
the porous layer being provided between the nonaqueous electrolyte secondary battery separator and at least one of the positive electrode plate and the negative electrode plate,
the polyvinylidene fluoride-based resin contained in the porous layer containing an α-form polyvinylidene fluoride-based resin in an amount of not less than 35.0 mol % with respect to 100 mol % of a combined amount of the α-form polyvinylidene fluoride-based resin and a β-form polyvinylidene fluoride-based resin contained in the polyvinylidene fluoride-based resin,
a content of the α-form polyvinylidene fluoride-based resin being calculated by (i) waveform separation of (α/2) observed at around −78 ppm in a ¹⁹F-NMR spectrum obtained from the porous layer and (ii) waveform separation of {(α/2)+β} observed at around −95 ppm in the ¹⁹F-NMR spectrum obtained from the porous layer.

2. The nonaqueous electrolyte secondary battery as set forth in claim 1, wherein the positive electrode plate contains a transition metal oxide.

3. The nonaqueous electrolyte secondary battery as set forth in claim 1, wherein the negative electrode plate contains graphite.

4. The nonaqueous electrolyte secondary battery as set forth in claim 1, further comprising:
another porous layer which is provided between (i) the nonaqueous electrolyte secondary battery separator and (ii) at least one of the positive electrode plate and the negative electrode plate.

5. The nonaqueous electrolyte secondary battery as set forth in claim 4, wherein the another porous layer contains at least one resin selected from the group consisting of a polyolefin, a (meth)acrylate-based resin, a fluorine-containing resin (excluding a polyvinylidene fluoride-based resin), a polyamide-based resin, a polyester-based resin, and a water-soluble polymer.

6. The nonaqueous electrolyte secondary battery as set forth in claim 5, wherein the polyamide-based resin is aramid resin.
